(19) United States
(12) Patent Application Publication
(10) Pub. No.: US 2003/0097433 A1
(43) Pub. Date: May 22, 2003

(54) Platform-independent apparatus and method for automatically searching, distributing and installing software

(76) Inventors: Ji Eun Park, Taejon (KR); Dong Won Han, Taejon (KR); June Sakong, Seoul (KR); Chae Kyu Kim, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 10/108,482

(22) Filed: Mar. 29, 2002

(30) Foreign Application Priority Data
Nov. 2, 2001 (KR) 2001-68230

(51) Int. Cl. G06F 15/16

(52) U.S. Cl. 709/222; 717/176

(57) ABSTRACT

An apparatus and a method for automatically searching, distributing and installing software from a web site to mobile devices is disclosed. The present invention implements the open script description (OSD) as a standard for processing a web based information and also implements the SynchML as data synchronization standard for installing and renewing software process. The present invention also provides a server loader and a device loader with above-mentioned implementations therefore widely distributed application programs of mobile devices on web sits can be automatically monitored, downloaded and installed platform independently to the mobile device.

### FIELD OF THE INVENTION

The present invention relates to a method for searching, distributing and installing application software for use in mobile devices; and, more particularly, to a method for automatically searching, distributing and installing software, which is commonly applicable to various mobile devices, different operating systems and various application software downloading sites, i.e., platform-independent, and a computer readable recording medium on which a program for implementing the method is recorded.

### DESCRIPTION OF RELATED ARTS

In general, application software for a mobile device, which includes a PDA (Personal Digital Assistant) and a HPC (Handheld Personal Computer), is mostly introduced and distributed through exclusive websites. Therefore, a user of the mobile device needs to go through several steps for installing a desired program into the mobile device such as surfing the exclusive web sites for finding the desired program, downloading the desired program to a desktop personal computer, attaching the mobile device to the desktop personal computer physically by using a communication link and then installing the downloaded program into the mobile device through the communication link by using an application software transferring and synchronizing program between the desktop personal computer and the mobile device. Additionally, the user needs to monitor the exclusive web sites regularly for upgrading installed programs and finding newly introduced programs.

The above-mentioned inconvenience tasks for installing the desired program into the mobile device are troublesome, annoying and time consuming processes not only to beginners of the mobile device but also to experts.

The users of the mobile devices have been demanding an apparatus for automatically searching desired software from web sites, and distributing and installing the searched software to the mobile devices without user's participation.

In the meantime, there is introduced a method for automatically searching and installing desired software from a specific web site, in commonly owned Korean Patent Application No. 2000-52348, entitled “AUTOMATIC APPLICATION SOFTWARE INSTALLING AGENT FOR MOBILE COMMUNICATION DEVICE”. The method is briefly explained herein below.

This automatic software installing agent includes a web information managing unit, a user's taste managing unit, a communication managing unit and a software installation managing unit. The web information managing unit monitors and analyzes update information of web documents in a web server through which application software for a personal data assistant (PDA) is notified in every predefined interval through a communication link by using a communication platform inside a PDA. The user's taste managing unit stores and manages information representing tastes of PDA users. The communication managing unit instructs the software installation managing unit to install new or updated software if it is posted from the web information managing unit that there is notified the new or updated software on the web server. The software installation managing unit downloads and installs the new or updated software from the web server into the PDA according to the instruction of the communication managing unit. This agent provides a convenient method for using recently updated and/or newly introduced software dedicated to PDAs. By using this method, even general users of PDAs can readily search, download the newest application software from the web site and install it into their PDAs without carrying out time consuming and annoying processes. Further, there is obtained an effect to reduce additional efforts of the users required in continuous web-monitoring and software information search. The agent also implements more effective services by pre-storing information representing user's tastes such as a web monitoring interval and kinds of software to be downloaded, comparing the pre-stored information and web information provided by the web server and applying the comparison result to a service processing.

However, since the above method searches and installs software depending on a specific web site instead of applying the standardization to performing major functions such as mobile communication and web analysis, it is almost impossible to implement the above method for automatically searching and distributing application software posted on widely distributed web sites into various types of the mobile devices with heterogeneous operating systems installed.

### SUMMARY OF THE INVENTION

It is, therefore, an object of the present invention to provide an apparatus and method for automatically searching and distributing application software from various web sites into mobile devices with different operating systems installed without a user's participation by providing a web-searching module for analyzing an open script description (OSD), which is an open specification for the standardization of major functions of the PDA application software and web sites, and for detecting a desired information and providing an automatic distribution module based on a synchronization Markup Language (SyncML) for automatically distributing the application software.

Another object of the present invention is to provide an apparatus and method for automatically installing application software from various web sites into mobile devices with different operating systems installed without a user's participation by providing a synchronization markup language (SyncML) framework for data synchronization between a mobile device and a desktop PC.

Still another object of the present invention is to provide a computer readable recording medium on which a program for executing the above methods for automatically searching, distributing, installing application software is recorded.

In accordance with an aspect of the present invention, there is provided a platform-independent software searching and distributing apparatus, including: an open script description (OSD) analyzing unit for searching, analyzing and detecting software information posted on a website and downloading software corresponding to the detected software information from the web site; a web posted software information managing unit for managing the detected software information and the downloaded software as a database; and a server loader SyncML processing unit for transmitting modified software database information, which is managed by the web posted software information managing unit, to a SyncML processing unit of a device loader according to a SyncML protocol.

In accordance with another aspect of the present invention, there is also provided a platform-independent software searching and distributing method implemented into a platform-independent software searching, distributing and installing apparatus, including the steps of: a) starting an automatic software searching and distributing procedure according to the generation of an external event; b) downloading a web document for automatically searching software if the external event is a web-searching event; c) analyzing the web document after completing the downloading of the web document; d) detecting software information from an open script description (OSD) document analysis tree for the web document after analyzing the web document; e) downloading software from a web site and storing downloaded software in a temporary storage; f) storing the detected software information from the step (d) and the downloaded software at a software information database; g) requesting data synchronization to a device loader, which automatically installs software, incase the external event is a data synchronization event; h) detecting a modified information from the software information database when the device loader responses to the request of the step (g); i) converting the detected modified information to a SyncML document and transmitting the SyncML document to the device loader; j) sending mapping information to the device loader after receiving response from the device loader which received the SyncML document; and k) storing the mapping information into a mapping table when the device loader responses for state information of the mapping information.

In accordance with another aspect of the present invention, there is also provided a platform-independent software installing method implemented into a platform-independent software searching, distributing and installing apparatus, including the steps of: a) sending an acceptance message for data synchronization when a synchronization request event is generated from a server loader; b) receiving modified database information from the server loader after the acceptance message; c) confirming whether software transmitted from the server loader is installed or not after transmitting the received modified database information to a user; d) renewing a software information database in the device loader based on information for software to be installed in the device loader after receiving a response for the confirmation of the step c); e) sending state information to the server loader after renewing the software information database in the device loader; f) receiving mapping information from the server loader after sending the state information; g) detecting an identifier of the device loader by using the received mapping information from the server loader and noticing the detected identifier to the server loader; and h) downloading the software to be installed from the server loader and installing the downloaded software after transmitting the information for the software to be installed to the user of the device loader.

In accordance with another aspect of the present invention, there is also provided A computer readable recording medium for executing automatic software searching and distributing method implemented into a platform-independent searching, distributing and installing apparatus, including functions of: a) starting an automatic software searching and distributing procedure according to the generation of an external event; b) downloading a web document for automatically searching software if the external event is a web-searching event; c) analyzing the web document after completing the downloading of the web document; d) detecting software information from an open script description (OSD) document analysis tree for the web document after analyzing the web document; e) downloading software from a web site and storing downloaded software in a temporary storage; f) storing the detected software information from the step (d) and the downloaded software at a software information database; g) requesting data synchronization to a device loader, which automatically installs software, incase the external event is a data synchronization event; h) detecting a modified information from the software information database when the device loader responses to the request of the step (g); i) converting the detected modified information to a SyncML document and transmitting the SyncML document to the device loader; j) sending mapping information to the device loader after receiving response from the device loader which received the SyncML document; and k) storing the mapping information into a mapping table when the device loader responses for state information of the mapping information.

In accordance with another aspect of the present invention, there is also provided a computer readable recording medium for executing the platform-independent software installing method implemented into a platform-independent software searching, distributing and installing apparatus, including the functions of: a) sending an acceptance message for data synchronization when a synchronization request event is generated from a server loader; b) receiving modified database information from the server loader after the acceptance message; c) confirming whether software transmitted from the server loader is installed or not after transmitting the received modified database information to a user; d) renewing a software information database in the device loader based on information for software to be installed in the device loader after receiving a response for the confirmation of the step c); e) sending state information to the server loader after renewing the software information database in the device loader; f) receiving mapping information from the server loader after sending the state information; g) detecting an identifier of the device loader by using the received mapping information from the server loader and noticing the detected identifier to the server loader; and h) downloading the software to be installed from the server loader and installing the downloaded software after transmitting the information for the software to be installed to the user of the device loader.

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic block diagram illustrating an implementation concept of a platform independent apparatus for automatically searching, distributing and installing application software for mobile devices in accordance with the preferred embodiment of the present invention;

FIG. 2 is a schematic block diagram of a platform independent apparatus for automatically searching, distributing and installing application software for mobile device in accordance with the present invention;

FIG. 3 is a flowchart illustrating an application software automatic searching, distributing and installing operation of server loader in the platform-independent apparatus for automatically searching, distributing and installing application software for mobile devices in accordance with the embodiment of the present invention; and

FIG. 4 is a flowchart illustrating an automatic software installing operation of a device loader in the platform-independent apparatus for automatically distributing automatic searching distributing and installing application software for mobile devices in accordance with the embodiment of the present invention.

### DETAILED DESCRIPTION OF THE INVENTION

Other objects and aspects of the invention will become apparent from the following description of the embodiments with reference to the accompanying drawings, which is set forth hereinafter.

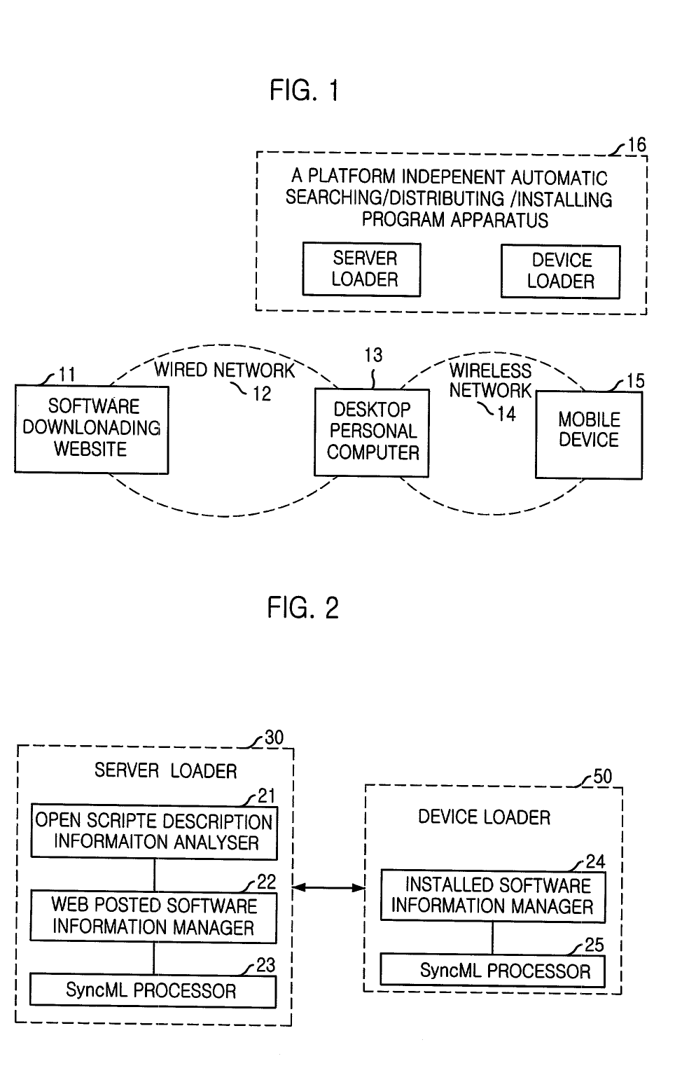

FIG. 1 is a schematic block diagram illustrating an implementation concept of a platform independent apparatus for automatically searching, distributing and installing application software for mobile devices in accordance with the preferred embodiment of the present invention.

As shown in FIG. 1, the platform independent software automatic searching, distributing and installing apparatus 16 automatically searches and downloads software by using a desktop PC 13 and an open script description OSC-based software downloading web site 11, and distributes the downloaded software from the desktop PC 13 to a mobile device 15.

The OSD-based software downloading website 11 is built by implementing an OSD as a standard open specification and the desktop PC 13 is connected to the OSD-based software downloading web site 11 though a wired network 12. The desktop PC 13 and the mobile device 15 are connected through a wireless network 14.

A detailed description of the platform-independent searching, distributing and installing apparatus is shown as follows.

The OSD-based software downloading web site 11 is a web site dedicated to mobile devices, which posts information of application software in the form of the OSD.

The desktop PC 13 includes a server loader of the platform-independent software searching, distributing and installing apparatus loaded there in.

The mobile device 15 includes a device loader of the platform-independent software searching, distributing and installing apparatus.

The platform-independent software searching, distributing and installing apparatus in accordance with the present invention includes the server loader and the device loader. The server loader analyzes, detects and manages software information posted on the web site. The device loader transmits and receives the software information and downloaded software through via the wireless network by using the server loader and a SyncML protocol.

FIG. 2 is a schematic block diagram of a platform independent apparatus for automatically searching, distributing and installing application software for mobile device in accordance with the present invention.

As shown in FIG. 2, the platform-independent software searching, distributing and installing apparatus includes a server loader 30 and a device loader 50.

The server loader 30 is composed of an open script description (OSD) analyzer 21, a web posted software information manager 22 and a SyncML processor 23.

The OSD analyzer 21 searches, analysis and detects software information written in the form of the OSD and downloads the program from a web site to thereby distributing application software to a mobile device platform-independently.

The web posted software information manager 22 manages detected software information from the OSD analyzer 21 and the downloaded software as a database.

The synchML protocol processor 23 includes functions for converting database information for changed software of the web posted software information manager 22 to a SyncML document, which is a standard document for data synchronization between the desktop PC and the mobile device, and transmitting the SyncML document to a SyncML processor 25 in the device loader 50 according to the SyncML protocol.

The device loader 50 includes the SyncML processor 25 and software information manager 24. The SyncML processor 25 analyzes the transmitted new software information from the SyncML processor 23 of the server loader 30. The software information manager 24 manages application software information installed in the device loader 50 as a database. In other words, analyzed software information of the SyncML processor 25 is noticed to a user and the user instructs to install a desired program if there is the desired program in the software information. The software information manager 24 manages information of the installed application program.

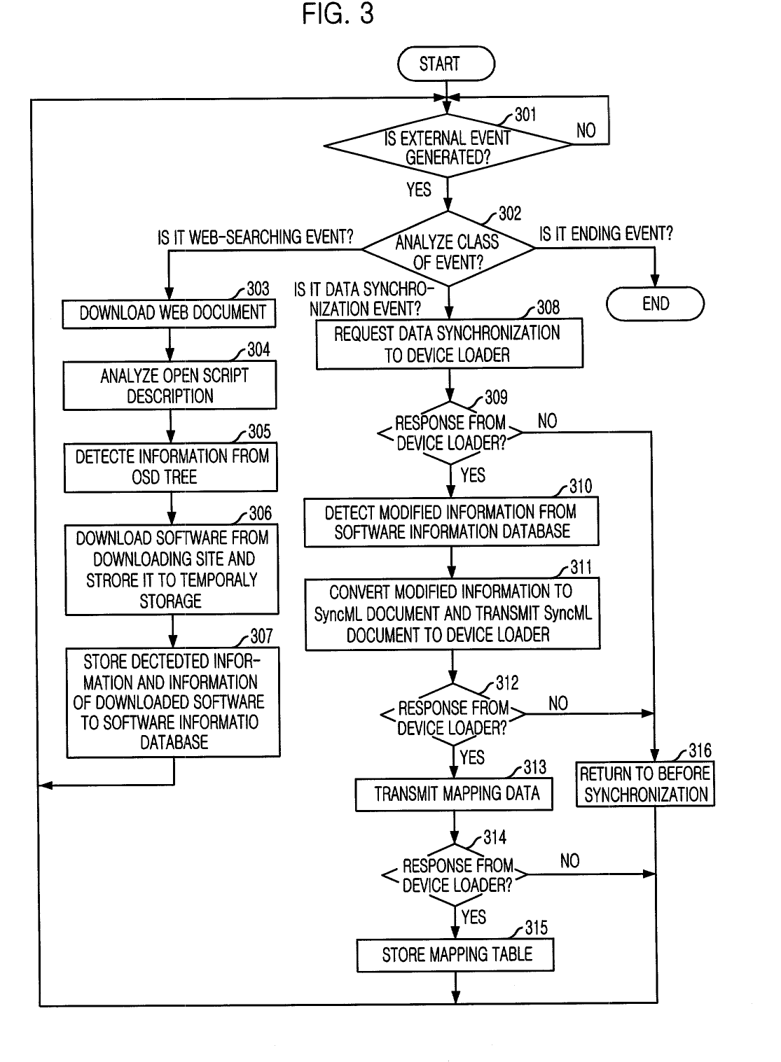

FIG. 3 is a flowchart illustrating an application software automatic searching, distributing and installing operation of server loader in the platform-independent apparatus for automatically searching, distributing and installing application software for mobile devices in accordance with the embodiment of the present invention.

The server loader 30 automatically searches application software in a web site and automatically distributes the searched application software to the mobile device. The software searching procedure of the server loader 30 is composed of steps 303 to 307 and the software distributing procedure is composed of steps 308 to 316.

The automatic software searching and distributing procedure is invoked by a generation of events such as a web-searching event for the software searching procedure and a data synchronization event for the data synchronization with the device loader 50 for the software distributing method.

The web-searching event is generated in a fixed interval by a request of a web monitoring and invokes an operation of searching application software posted on web sites.

If the web-searching event is generated, then a web document is downloaded from the OSD-based software downloading web site 11 by using web site information pre-stored by a user at step 303. After completing the downloading of the web document, the web document is analyzed according to the OSD form at step 304. After completing the document analysis, information for the application software is detected from an OSD document analysis tree at step 305. The detected information is stored at a software information database for the synchronization for the software information with the device loader 50 at steps of 306 and 307.

When the detected information is stored into the software information database, the downloading process is also performed by using information for the web site. The downloaded software is stored in a temporary storage and information for the temporary storage is also stored in the software information database. If the above storage process is completed, then this procedure is returned back to an external event generation mode so as to wait for another external event.

The data synchronization event invokes an operation of automatically distributing application software information searched from the web site to the device loader 50 by executing the data synchronization between the server loader 30 and the device loader 50. The data synchronization event can be invoked by a user's request or can be invoked by a preset interval. If the data synchronization event is generated at step 302, the server loader 30 requests the data synchronization for the application software to the device loader 50 at step 308.

A message transmission between the server loader 30 and the device loader 50 for the data synchronization is progressed according to a definition of the SyncML protocol. If the server loader 30 receives the acceptance acknowledgement of the data synchronization request from the device loader 50, the server loader 30 detects software information from the software information database modified after the previous data synchronization process at step 310. The modified software information of the server loader 30 is converted to a SynchML document and the converted SynchML document is transmitted to the device loader 50 at step 311. In case the server loader 30 receives a response for the transmission from the device loader 50 at step 312, the server loader 30 transmits mapping information for each data, which is newly shared with the device loader 50, to the device loader 50 at step 313. The mapping information for each data contains an identifier of identical software installed in both of the server loader and the device loader.

If the server loader 30 receives a response for the transmitted mapping information from the device loader 50 at step 314, the server loader 30 analyzes the response message and stores the identifier of the software information database of the server loader and an identifier of the software information database of the device loader 50 for the identical data as a pair in a mapping table at step 315. If the server loader 30 does not receive the response for the transmitted mapping information from the device loader 50 at step 314, this procedure is returned back to the step before the synchronization at step 316.

If the step of storing the mapping information is completed, this procedure is returned back to the external event generation mode to wait for another external event generated.

If the external event is an ending event, the server loader 30 terminates its operation.

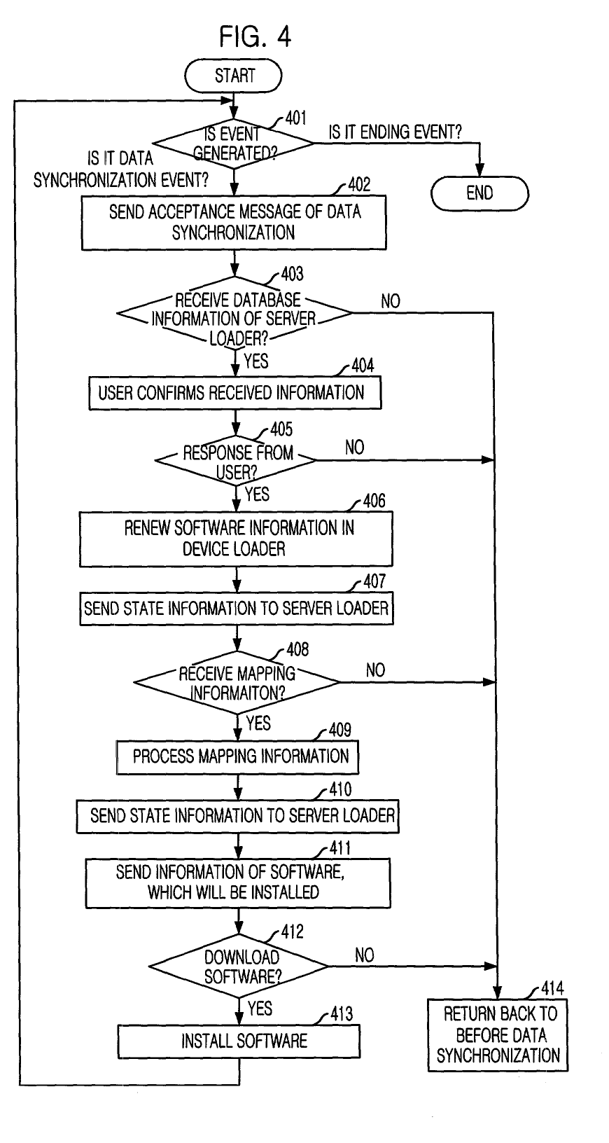

FIG. 4 is a flowchart illustrating an automatic software installing operation of a device loader in the platform-independent apparatus for automatically distributing automatic searching distributing and installing application software for mobile devices in accordance with the embodiment of the present invention.

The application software distributing procedure of the device loader 50 is invoked by a synchronization request of the server loader 30 at step 401.

If the server loader 30 generates a synchronization request event, the device loader 50 receives the synchronization request from the server loader 30 and sends an acknowledgement of acceptance to the server loader 30 at step 402. After sending the acknowledgement of acceptance, the device loader 50 receives software information converted to a SyncML document from the server loader 30 at step 403.

The device loader 50 determines whether the received software information is information for software pre-installed by a user. The device loader 50 notices received software information except information for the pre-installed software to the user at step 404.

Software information, which is information for application software user wants to install, among the received software information and the software information received from the server loader 30 are the used to renew information stored in the software information database of the device loader 50 at step 406.

After renewing the information, state information for the renewing result is transmitted to the server loader 30 at step 407. After renewing the state information the server loader 30 transmits mapping information to the device loader 50 at step 408. The mapping information is a table of mapping software information database identifiers of both loaders for identical software between the server loader 30 and the device loader 50. That is, if identical record of the software information database are existed in both of the server loader 30 and the device loader 50, the server loader 30 manages identifiers of identical records as a table. The device loader 50 detects a data identifier corresponding to the received mapping information at step 409 and sends it to the server loader 30 at step 410.

The above-mentioned mapping information transmission between the server loader 30 and the device loader 50 can be explained in detail with a below example.

The software information database in the server loader 30 contains newly posted or upgraded software information on a web site and software information, which is already installed in the device loader 50. The information may be stored as a record with following fields.

SERVER.ID: 01

SERVER.NAME: WinZip

ABSTRACT: software for file compression

SERVER.VERSION: 1.8

LOADER.ID: 03

The software information database in the device loader 50 contains the software information, presently installed therein. The information may be also stored as a following record below.

ID: 03

NAME: WinZip

ABSTRACT: software for file compression

VERSION: 1.8

The WinZip record in the mapping table of the server loader 30 contains information of identical WinZip record in the device loader 50 having the “ID” as 03. In this status, if the WinZip software posted in the web site is upgraded from version 1.8 to version 1.9, the information of the WinZip record in the server loader 30 is updated. In other words, the fields of the WinZip record of the server loader 30 having the “SERVER.ID” as 01 is modified according to the updated information of the web site.

At this point, if data synchronization is requested to the device loader 50, the device loader 50 is invoked to update the software with the “ID” 03 by comparing fields of identical records in the mapping table in the server loader 30 and the device loader 50.

After comparing the mapping data, the user is noticed software information to be updated or to be installed at step 411. The device loader 50 downloads the software to be installed from the server loader 30 at step 412.

If the software downloading is completed, the device loader 50 installs the downloaded software in the mobile device at step 413.

If the user does not response the notice at step 411 or the server loader 30 does not have updated software information, this procedure is returned back to the step before the data synchronization at step 414.

The platform-independent software searching, distributing and installing apparatus can be implemented into not only the desktop PC but also various types of devices searching and distributing application software of the mobile devices based on the OSD and the SyncML.

The above-mentioned methods can be implemented as a software program and stored in a computer readable recording medium including a CD-ROM, a RAM, a floppy disk, a hard disk, a magneto-optical disk and so on.

The present invention implements the OSD as a standard for processing web information. Therefore, the present invention can automatically search application software for mobile devices from any web site following the OSD.

Since the present invention also implements the SynchML as data synchronization standard for a software installing and renewing process between a server loader and a device loader, the present invention is platform-independent. That is, it can be commonly applied to various devices with heterogeneous operating systems.

The present invention provides a server loader and a device loader for automatically monitoring web sites, which provides valuable mobile device software, and automatically downloading and installing the program to the mobile devices. Therefore, the present invention improves the conventional software management method.

While the present invention has been described with respect to certain preferred embodiments, it will be apparent to those skilled in the art that various changes and modifications may be made without departing from the scope of the invention as defined in the following claims.

What is claimed is:

1. A platform-independent software searching and distributing apparatus, comprising:
an open script description (OSD) analyzing means for searching, analyzing and detecting software information posted on a website and downloading software corresponding to the detected software information from the web site;
a web posted software information managing means for managing the detected software information and the downloaded software as a database; and
a server loader SyncML processing means for transmitting modified software database information, which is managed by the web posted software information managing means, to a SyncML processing means of a device loader according to a SyncML protocol.

2. The platform-independent software searching and distributing apparatus as recited in claim 1, wherein the OSD analyzing means searches, analyzes and detects the software information, which is written in the OSD form.

3. The platform independent searching and distributing apparatus as recited in claim 1, wherein the server loader SyncML processing means converts the modified software database information managed by the web posted software information managing means to a SyncML document.

4. A platform independent software installing apparatus interlocked with the platform-independent automatic software searching and distributing apparatus of claim 1, comprising:
a device loader SyncML processing means for receiving new software information from the sever loader SyncML processing means of the platform-independent software searching and distributing apparatus according to a SyncML protocol; and
an information managing means for receiving the software information from the device loader SyncML processing means and managing application software information, which is installed by a user's request, by using the record software information.

5. A platform-independent software searching and distributing method implemented into a platform-independent software searching, distributing and installing apparatus, comprising the steps of:
a) starting an automatic software searching and distributing procedure according to the generation of an external event;
b) downloading a web document for automatically searching software if the external event is a web-searching event;
c) analyzing the web document after completing the downloading of the web document;
d) detecting software information from an open script description (OSD) document analysis tree for the web document after analyzing the web document;
e) downloading software from a web site and storing downloaded software in a temporary storage;
f) storing the detected software information from the step (d) and the downloaded software at a software information database;
g) requesting data synchronization to a device loader, which automatically installs software, incase the external event is a data synchronization event;
h) detecting a modified information from the software information database when the device loader responses to the request of the step (g);
i) converting the detected modified information to a SyncML document and transmitting the SyncML document to the device loader;
j) sending mapping information to the device loader after receiving response from the device loader which received the SyncML document; and
k) storing the mapping information into a mapping table when the device loader responses for state information of the mapping information.

6. The platform-independent software searching and distributing method as recited in claim 5, wherein the data synchronization event is invoked in a fixed interval, which is preset by a user.

7. The platform-independent software searching and distributing method as recited in claim 5, wherein the web document is analyzed based on the OSD.

8. A platform-independent software installing method implemented into a platform-independent software searching, distributing and installing apparatus, comprising the steps of:
a) sending an acceptance message for data synchronization when a synchronization request event is generated from a server loader;
b) receiving modified database information from the server loader after the acceptance message;
c) confirming whether software transmitted from the server loader is installed or not after transmitting the received modified database information to a user;
d) renewing a software information database in the device loader based on information for software to be installed in the device loader after receiving a response for the confirmation of the step c);
e) sending state information to the server loader after renewing the software information database in the device loader;
f) receiving mapping information from the server loader after sending the state information;
g) detecting an identifier of the device loader by using the received mapping information from the server loader and noticing the detected identifier to the server loader; and
h) downloading the software to be installed from the server loader and installing the downloaded software after transmitting the information for the software to be installed to the user of the device loader.

9. The platform-independent software installing method as recited in claim 8, wherein the modified database information is received from the server loader according to a SynchML protocol.

10. The platform independent software installing method as recited in claim 8, wherein the mapping information contains identifier of the software information database of each loader for identical software between the server loader and the device loader.

11. A computer readable recording medium for executing automatic software searching and distributing method implemented into a platform-independent searching, distributing and installing apparatus, comprising functions of:
a) starting an automatic software searching and distributing procedure according to the generation of an external event;
b) downloading a web document for automatically searching software if the external event is a web-searching event;
c) analyzing the web document after completing the downloading of the web document;
d) detecting software information from an open script description (OSD)) document analysis tree for the web document after analyzing the web document;
e) downloading software from a web site and storing downloaded software in a temporary storage;
f) storing the detected software information from the step (d) and the downloaded software at a software information database;
g) requesting data synchronization to a device loader, which automatically installs software, incase the external event is a data synchronization event;
h) detecting a modified information from the software information database when the device loader responses to the request of the step (g);
i) converting the detected modified information to a SyncML document and transmitting the SyncML document to the device loader;
j) sending mapping information to the device loader after receiving response from the device loader which received the SyncML document; and
k) storing the mapping information into a mapping table when the device loader responses for state information of the mapping information.

12. A computer readable recording medium for executing the platform-independent software installing method implemented into a platform-independent software searching, distributing and installing apparatus, comprising the functions of:
a) sending an acceptance message for data synchronization when a synchronization request event is generated from a server loader;
b) receiving modified database information from the server loader after the acceptance message;
c) confirming whether software transmitted from the server loader is installed or not after transmitting the received modified database information to a user;
d) renewing a software information database in the device loader based on information for software to be installed in the device loader after receiving a response for the confirmation of the step c);
e) sending state information to the server loader after renewing the software information database in the device loader;
f) receiving mapping information from the server loader after sending the state information;
g) detecting an identifier of the device loader by using the received mapping information from the server loader and noticing the detected identifier to the server loader; and
h) downloading the software to be installed from the server loader and installing the downloaded software after transmitting the information for the software to be installed to the user of the device loader.
